(19) United States
(12) Patent Application Publication
(10) Pub. No.: US 2007/0033190 A1
(43) Pub. Date: Feb. 8, 2007

(54) Unified storage security model

(75) Inventors: Gerald Michael Dodaro, Redmond, WA (US); Michael Alfred Aday, Bellevue, WA (US); Sean P. Grimaldi, Bellevue, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/199,480

(22) Filed: Aug. 8, 2005

(51) Int. Cl. G06F 17/30

(52) U.S. Cl. 707/9

(57) ABSTRACT

Access control data is transcoded or translated into a unified format. The unified format is acceptable and extensible so that other control languages can be transcoded into the unified format. Rights management information may be converted to unified storage metadata for use in a unified storage system. The construction of a data object that contains data and rights management information comprises transcoding both the original data to the unified storage format as well as transcoding the rights management information from any of a number of platforms to the rights management format used by the unified storage platform. Transcoding may occur in a transacted environment so that failures to complete will not degrade or lose data and rollback is possible if the process fails.

### BACKGROUND

Data storage/management systems and rights management systems may each be implemented in various diverse manners. Thus, many rights management formats are incompatible with each other. Unified storage makes it possible to treat various data storage/management data formats similarly from both a developer perspective, by using an API architecture that implements a superset of the different underlying systems, and a user interface perspective, allowing data to be returned to the user in the preferred interface irrespective of the system that actually is acting as the host to the specific data. In order to associate rights management information about items referenced or contained in a unified storage system, it would be desirable to convert and/or create rights management information from the original format to a common format stored and used by unified storage.

Microsoft has published a model for combining rights management information and the data it protects in a single file using the COM protocol called structured storage. Structured storage defines a consistent metadata and schema for properties and data within the files in which it is used, while the implemented format of structured storage varies depending on the type of data and software with which it is designed to be used. It always draws from a consistent schema to identify aspects of the files. Structured storage is compatible with Microsoft rights management techniques as well as other rights management protocols. It is desirable to insure a uniform and consistent user experience, by abstracting the various formats into a uniform schema and metadata that will allow a user to access, at a level appropriate to the rights management specifications on the data, data that is stored or referenced by unified storage.

In view of the foregoing, there is a need for systems and methods that overcome such deficiencies and provide a common rights management model to go with the common data model.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Conventional implementations of unified storage are extended with a uniform schema to allow for a rights management engine to provide uniform rights management behaviors across different types of rights management systems when they are being used in conjunction with unified storage.

Access control data is transcoded or translated into a unified format. The unified format is acceptable and extensible. Other control languages can be transcoded into the unified format.

Rights management information may be converted to unified storage data for use in a unified storage system. The construction of a data object that contains data and rights management information comprises transcoding both the original data (if not already in the unified storage format) to the unified storage format as well as transcoding and/or creating the rights management information to the rights management format used by the unified storage platform.

### BRIEF DESCRIPTION OF THE DRAWINGS

FIG. 1 is a block diagram of an example system for transcoding and storing rights management information in accordance with the invention.

FIG. 2 is a diagram showing various example rights management formats.

FIG. 3 is a flow diagram of an example method of transcoding and storing rights management information in accordance with the invention.

FIG. 4 is a block diagram showing an exemplary computing environment in which aspects of the invention may be implemented.

### DETAILED DESCRIPTION

The subject matter is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

A conventional model of unified storage requires file transcoding when data files are added to or removed from the unified storage system. This transcoding of the data storage/management data is done to make the file usable by the unified storage system and preserve the original structure so it can, if necessary, be demoted to its original state. The invention is directed to addition of a rights management promotion/demotion phase that converts rights management information to unified storage metadata for use in the unified storage system.

A unified security model which may include rights management should be applicable to data in unified storage regardless of the rights management formats protecting original data. There are various types of data formats and rights management formats. An extension to the classes used to contain data in the unified storage system has been devised to contain rights management information. In this model, security metadata is converted from the native system to a single format—a process that referred to as transcoding. This transcoded format desirably becomes part of the data object when it is added to storage.

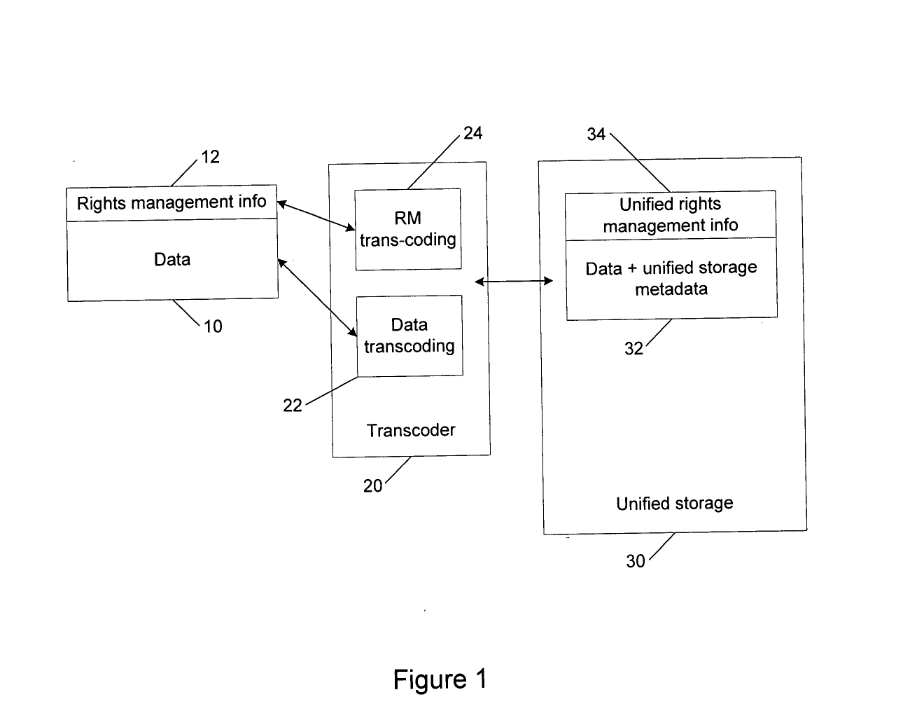

FIG. 1 is a block diagram of an example system for transcoding and storing rights management information in accordance with the invention. Data 10 with rights management information 12 is provided to a transcoder 20. The data 10 is transcoded 22 into data with unified storage metadata 32, and the rights management information 12 is also transcoded 24 into an intermediate format, and ultimately into unified rights management information 34. The transcoding allows for the data with unified storage metadata 32 and unified rights management information 34 to be stored in unified storage system 30. A compound file can be created that contains both the unified storage metadata 32 and unified rights management information 34. The unified storage system 30 consumes data of various formats translated by the transcoder into a common target format. The unified storage system 30 stores the rights management information that has been transcoded by the transcoder 20. More particularly, the unified storage system 30 stores data in such a way that it associates the rights management data with the data protected by the rights.

Access control data is transcoded or translated into a unified format. The unified format is acceptable and extensible so that other control languages can be transcoded into the unified format. In this model, the construction of a data object that contains data and rights management information involves transcoding both the original data to the unified storage format as well as transcoding the rights management information from any of a number of platforms to the rights management format used by the unified storage platform. Transcoding may occur in a transacted environment so that failures to complete will not degrade or lose data and rollback is possible if the process fails.

Desirably, groups of data objects to be changed simultaneously can be aggregated. Rights are also desirably assignable in aggregate based on user, hardware, data type, or associations between items.

Thus, data with rights management information is promoted/demoted to/from a unified storage model. Both data and rights management information is desirably converted in order to implement a unified security model.

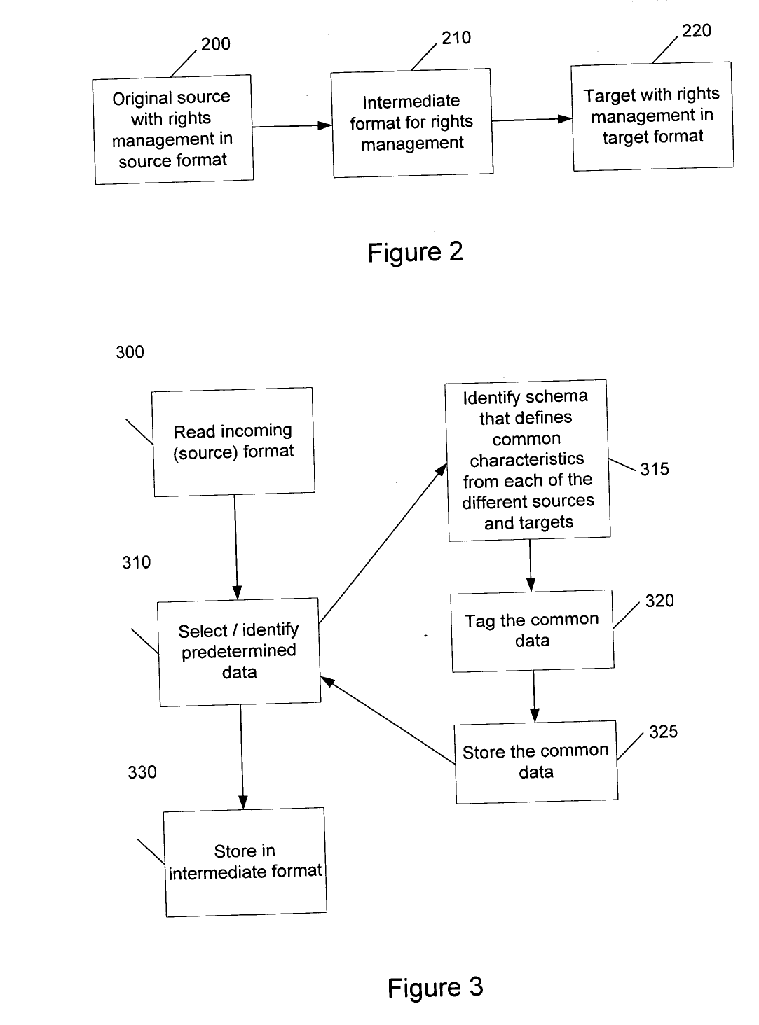

FIG. 2 is a diagram showing various example rights management formats. A source has a source format 200 for rights management, and a target has a target format 220 for rights management. Desirably, an intermediate format 210 for rights management is generated and stored. The intermediate format is desirably extensible, self-describing, and can be expanded to local security conventions. The intermediate format 210 is a transcoded format that is used as an intermediary between known source and target formats.

A schema may be referenced by the transcoder after the source and target formats have been specified. The schema defines common characteristics or data from the source and the target, for example. If no target format is specified, then the transcoding effort may stop at the intermediate format.

Example source and target formats include Apple, Sony, Windows rights management formats. The invention can be used with any rights management format or access control format.

FIG. 3 is a flow diagram of an example method of transcoding and storing rights management information. At step 300, an incoming or source format is read. Predetermined data is identified, at step 310. Identifying the predetermined data may comprise identifying a schema that defines common characteristics from each of the different sources and targets at step 315, tagging the common data at step 320, and storing it at step 325.

The schema may exist outside of the transcoding system, with the transcoding system making use of the schema. The schema preferably does not change based on the source or target format, and instead is maintained as constant. It is contemplated, however, that the schema may be upgraded and/or extended, e.g., using directory objects to get new or additional properties.

An example rights management schema is extensible right management language (XRML). This data is then stored in a new or intermediate format, at step 330. This intermediate form may be similar to element 210 in FIG. 2.

Thus, data comprising rights data and protected data is accessed from a source. The rights data is transcoded into a common format (i.e., an intermediate format for rights management) without degrading the quality of the underlying (attached) data. The transcoded data can be stored or translated into a target format.

Accuracy and security techniques may be used when converting to a unified format. This may be desirable to make sure that no additional rights are added beyond those in the original material.

It is noted that XRML draws on the self documenting capabilities of XML. The descriptors that are in the XRML are inherently self describing. Aspects of the invention may be implemented in a similar way so that the translation engines would not have to understand every potential format and so that the unified format can evolve. In such an example scenario, a field would be provided that described the version of the unified format that is being used on specific files. This would allow for the revision, updating, and extension of the schema that is used to describe the format without breaking the previously created instances of files that relied on the format of the previous version of the schema.

Exemplary Computing Environment

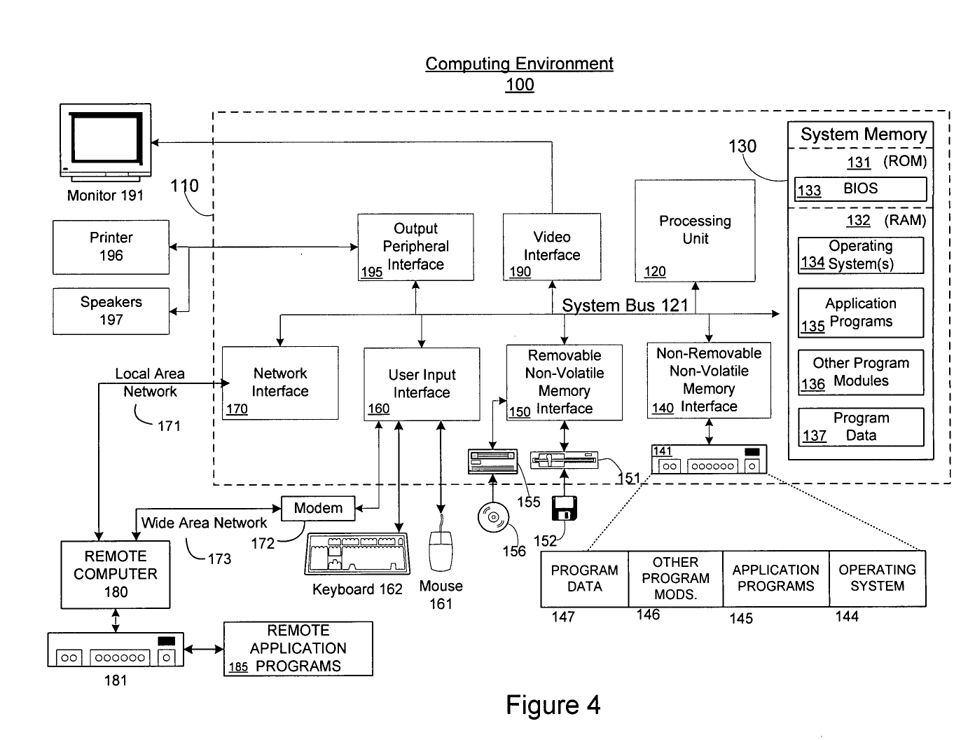

FIG. 4 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 4, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 4 illustrates operating system 134, application programs 135, other program modules 136, and program data 137.

The computer 110 may also include other removable/non-removable, volatile/nonvolatile computer storage media. By way of example only, FIG. 4 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 4, provide storage of computer readable instructions, data structures, program modules and other data for the computer 110. In FIG. 4, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 4. The logical connections depicted include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 4 illustrates remote application programs 185 as residing on memory device 181. It will be appreciated that the network connections shown are exemplary and other means of establishing a communications link between the computers may be used.

The various systems, methods, and techniques described herein may be implemented with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computer will generally include a processor, a storage medium readable by the processor (including volatile and non-volatile memory and/or storage elements), at least one input device, and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the invention. When implemented on a general-purpose processor, the program code combines with the processor to provide a unique apparatus that operates to perform the functionality of the present invention.

While the present invention has been described in connection with the preferred embodiments of the various figures, it is to be understood that other similar embodiments may be used or modifications and additions may be made to the described embodiments for performing the same functions of the present invention without deviating therefrom. Therefore, the present invention should not be limited to any single embodiment, but rather construed in breadth and scope in accordance with the appended claims.

What is claimed:

1. A method of transcoding and storing rights management information, comprising:
transcoding rights management information into an intermediate or universal format; and
storing the transcoded rights management information in a storage device.

2. The method of claim 1, wherein the intermediate or universal format is based on a source format and a target format.

3. The method of claim 1, wherein transcoding the rights management information comprises identifying schema that defines common characteristics from the source format and a target format.

4. The method of claim 3, wherein the schema comprises extensible rights management language.

5. The method of claim 1, wherein the storage device comprises unified storage.

6. The method of claim 1, wherein the transcoded rights management information comprises unified rights management information and unified storage metadata.

7. The method of claim 1, further comprising receiving data protected by the rights management information, transcoding the data, and storing the transcoded data in the storage device with the transcoded rights management information.

8. A rights management system, comprising:
a transcoder that receives rights management information and transcodes the rights management information into an intermediate or universal format; and
unified storage for storing the transcoded rights management information.

9. The system of claim 8, wherein the received rights management information is in a source format, and the intermediate or universal format is based on the source format and a target format.

10. The system of claim 8, wherein the transcoder identifies schema that defines common characteristics from a source format and a target format.

11. The system of claim 10, wherein the schema comprises extensible rights management language.

12. The system of claim 8, wherein the transcoded rights management information comprises unified rights management information and unified storage metadata.

13. The system of claim 8, wherein the transcoder receives data protected by the rights management information, transcodes the data, and stores the transcoded data in the unified storage with the transcoded rights management information.

14. A transcoder that transcodes rights management information into an intermediate or universal format, and provides the transcoded rights management information to unified storage.

15. The transcoder of claim 14, wherein the transcoder is adapted to receive the rights management information in a source format.

16. The transcoder of claim 15, wherein the intermediate or universal format is based on the source format and a target format.

17. The transcoder of claim 14, wherein the transcoder identifies schema that defines common characteristics from a source format and a target format.

18. The transcoder of claim 14, wherein the schema comprises extensible rights management language.

19. The transcoder of claim 14, wherein the transcoded rights management information comprises unified rights management information and unified storage metadata.

20. The transcoder of claim 14, wherein the transcoder receives data protected by the rights management information, transcodes the data, and stores the transcoded data in the unified storage with the transcoded rights management information.
